(19) United States
(12) Patent Application Publication
(10) Pub. No.: US 2004/0218790 A1
(43) Pub. Date: Nov. 4, 2004

(54) Print segmentation system and method

(76) Inventor: Peter Zhen Ping Lo, Lake Forest, CA (US)

Correspondence Address: MOTOROLA, INC., 1303 EAST ALGONQUIN ROAD, IL01/3RD, SCHAUMBURG, IL, 60196

(21) Appl. No.: 10/834,536

(22) Filed: Apr. 29, 2004

Related U.S. Application Data
(60) Provisional application No. 60/467,469, filed on May 2, 2003.

(51) Int. Cl. G06K 9/00; G06K 9/34

(52) U.S. Cl. 382/124; 382/171

(57) ABSTRACT

A method for segmenting a fingerprint image having a plurality of pixel includes the steps of: estimating the direction (400) of at least a portion of the plurality of pixels to generate a directional image from said fingerprint image; determining (500) at least one foreground component image of the directional image; calculating (800) a vertical projection profile of the at least one foreground component image; calculating (800) a horizontal projection profile of the at least one foreground component image; determining (1000) a plurality of segmentation edges based on the vertical and horizontal projection profiles; and segmenting (1100) a region of the fingerprint image based on the plurality of segmentation edges, whereby the region is included within the segmentation edges.

### FIELD OF THE INVENTION

This invention relates generally to pattern identification systems, and more particularly to a system and method for automatically segmenting a print area from a larger print area.

### BACKGROUND OF THE INVENTION

Identification pattern systems, such as fingerprinting systems, play an important role in modern society in providing public safety, such as for criminal identification, and in civil applications such as credit card or personal identity fraud. Modern automatic finger print identification systems (AFIS) may perform several hundred thousand to many millions of comparisons of prints, including fingerprints and palm prints, per second.

An automatic fingerprint identification operation normally includes two stages. The first is the registration stage and the second is the identification stage. In the registration stage, the register's fingerprints and personal information are enrolled and features, such as minutiae, are extracted. The prints, personal information and the extracted features may then be used to form a file record that may be saved into a database for subsequent print identification. Present day automatic fingerprint identification systems may contain several hundred thousand to several million of such file records.

In the identification stage, fingerprints from an individual are often re-enrolled. Features may then be extracted to form what is typically referred to as a search record. The search record may then be compared with the enrolled file records in the database of the fingerprint matching system.

In a typical Automated Fingerprint Identification Systems (AFIS), the fingerprint data is collected in the form of fourteen inked impressions on a conventional ten-print card, including the rolled (or flat or scanned) impressions of ten fingers as well as three slap impressions: the left slap (four fingers of the left hand), the right slap (the four fingers of the right hand) and the thumb slaps (the left and right thumbs). Normally, the ten rolled fingerprints may be selected to form a search record or file record.

The matching accuracy of ten-print cards generally depends on how the rolled (or flat or scanned) finger print impressions are obtained. Typically, a fingerprint is conventionally captured and scanned into the system at 500 dpi. The size of the conventional fingerprint block of the print form is usually on the order of about 800×800 pixels, depending on how the prints are enrolled. Ideally each individual fingerprint box should contain the desired fingerprint only; however, sometimes due to carelessness or inexperience of the enroller, a partial fingerprint may be included in a neighboring box. Moreover, the enrolled print may include a partial print below the crease (first joint) of the fingerprint. In other cases, the partial print below the crease may not be included in a subsequent enrollment.

Once a print is captured, determining the accuracy of matching in the AFIS system generally requires matching the same, or a substantially similar area of a print, no matter how the fingerprint is enrolled, or otherwise captured. The accurate and robust segmenting of a usable section of a fingerprint can reduce the errors that may occur due to freedom of rotation and/or translation encountered in the print matching process. Such segmentation also generally speeds up feature extraction and matching, since a smaller usable area of the print to be matched may be identified earlier in the matching process. An important effect of the segmentation is that the matching accuracy may be substantially improved due to the same usable area of the fingerprint being segmented in a consistent manner.

Many conventional methods of general image segmentation have been described in literature. Some of these methods have been directly applied to the fingerprint segmentation. Generally, these methods are for differentiating a foreground portion of a print from a background portion of a print. One such prior art method for segmenting a fingerprint image is illustrated by reference to FIGS. 1-3. FIG. 1 illustrates a segmentation process described in the prior art as a centroid point segmentation method. In this method, the foreground 10 of the print is found in the image processing, such as by thresholding a fingerprint image. At least one component of the foreground, e.g., the largest component 40, is kept to calculate the centroid point 50 of the component. If an N×N pixel-sized sub-image is required to be segmented from the original fingerprint image, four edges to segment the desired fingerprint area may be placed using the component centroid (xc, yc) 50 as a reference point. Thereafter, an N×N pixel-sized segment fingerprint image 20 (FIG. 2) from an M×M pixels-sized fingerprint image block may be obtained, where M is generally greater than N. The top, bottom, left and right segmented edges of the block are placed at plus or minus half of the desired segmented fingerprint length N from the centroid 50.

The problem with this method is that two different areas of the print may be segmented from two different impressions for the same person because of differences in enrollment. For example, the fingerprint from the first impression may contain only a fingerprint area above a first joint or crease line 30 in the M×M block, and a fingerprint from the second impression may contain a large portion of the fingerprint under the crease line 30. Accordingly, the centroid 50 detected in the first impression would generally be much higher than the centroid 50 detected in the second impression. Thus, the N×N segmented areas 20 from the two impressions would contain different areas of the same finger.

A representative conventionally derived fingerprint that has been segmented using a centroid point of the print is generally depicted in FIG. 3. As seen in FIG. 3, the segmented area does not include the top portion (e.g., “good fingerprint area”) of the finger, but does include a relatively large area below the crease or first joint. The fingerprint area below the crease may not be consistently captured from different enrollments. Thus, it is desirable that the fingerprint above the crease should first be preserved, and if N is larger than the fingerprint portion above crease, the partial fingerprint area below the crease may also be included.

One limitation of the above-described method of fingerprint segmentation (as well as other methods known in the art) is that this method does not address the problem of obtaining a foreground segment print area that fits a pre-determined size from a foreground area that is larger than that to provide a print segment that improves both the accuracy and speed of the matching print process. Another limitation is that these methods do not address how to segment the same region of a fingerprint from two impressions of the print captured at different times. Moreover, the fingerprints may be captured under many different scenarios such as over inked, under inked, dry skin or wet skin conditions of the candidate finger, etc. In the subsequent minutiae matching steps of the matching process, these unwanted background sections in the print images may adversely affect the accuracy, speed and quality of the matching. In order to make sure the fingerprint image is accurately and consistently segmented, each component image must be visually reviewed and corrected during the file conversion process.

Thus, it would be desirable to provide a system and method that improves the segmentation of an individual print to provide a more robust and accurate AFIS system.

### BRIEF DESCRIPTION OF THE FIGURES

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent to skilled artisans in light of certain exemplary embodiments recited in the detailed description, wherein:

FIG. 1 is a schematic drawing representing a fingerprint foreground determined by using a centroid point segmentation method, according to the prior art;

FIG. 2 is a schematic drawing representing a segment of a fingerprint image calculated from a centroid point of FIG. 1, according to the prior art.

FIG. 3 is an example of an actual finger print image segmented by the centroid of a component method of the prior art;

FIG. 4 is a flow diagram illustrating a segmentation method according to an embodiment of the present invention;

FIG. 5 is a graph illustrating the determination of a peak length according to an embodiment of the present invention; and

FIG. 6 illustrates segmentation edges of a box containing the segmented fingerprint of FIG. 3.

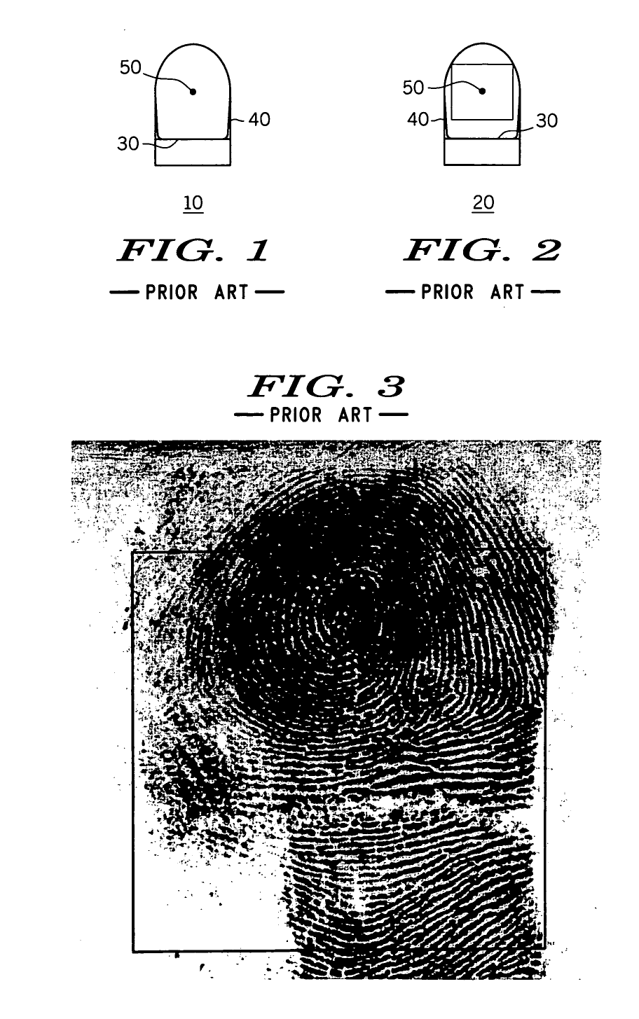

Those skilled in the art will appreciate that elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms ‘first’, ‘second’, and the like herein, if any, are used inter alia for distinguishing between similar elements and not necessarily for describing a sequential or chronological order. Moreover, the terms ‘front’, ‘back’, ‘top’, ‘bottom’, ‘over’, ‘under’, and the like in the Description and/or in the claims, if any, are generally employed for descriptive purposes and not necessarily for comprehensively describing exclusive relative position. Skilled artisans will therefore understand that any of the preceding terms so used may be interchanged under appropriate circumstances such that various embodiments of the invention described herein, for example, are capable of operation in other orientations than those explicitly illustrated or otherwise described.

### DETAILED DESCRIPTION OF THE INVENTION

The following descriptions are of exemplary embodiments of the invention and the inventor's conception of the best mode and are not intended to limit the scope, applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

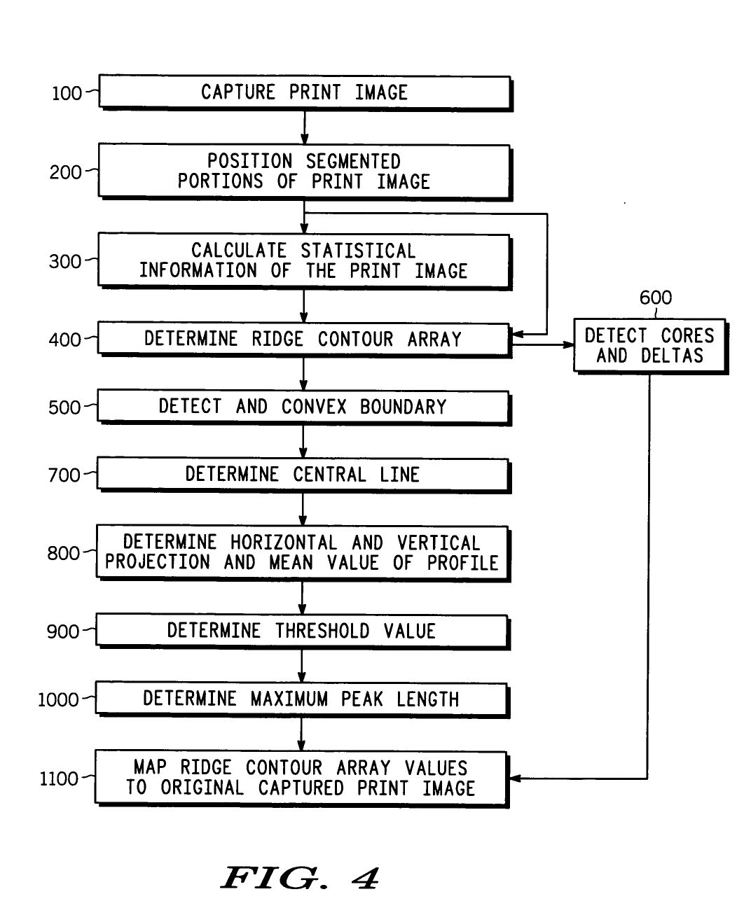

In FIG. 4, a system and method, in accordance with various representative and exemplary embodiments of the present invention, is generally disclosed. Since print segmentation affects the accuracy of matching and classification of prints, the finger segmentation system and method of the present system advantageously affects the overall AFIS system design. Returning to FIG. 4, in step 100 live images of fingerprints may be obtained by the rolled, flat and slap methods, typically using systems such as a Live Scan workstation commercially available from Printrak International, A Motorola Company located in Anaheim, Calif. The term “Slap prints” generally refers to a left slap (four fingers of the left hand), a right slap (four fingers of the right hand) and the thumb slaps (the left and right thumbs) applied to an inked media. In AFIS systems, the fingerprint data may be typically collected in the form of fourteen inked impressions (i.e., 10 rolled or flat prints and 4 slap prints) on a traditional print card. Images of prints may also be scanned from a print card in accordance with existing conventional methods.

If a fingerprint image is captured from a ten print live scanner by, for example the rolled method, the resulting rolled single fingerprint may be substantially directly sent to block 300 and block 400. If the fingerprint images are scanned from a fingerprint card, the card form may be recognized by a card form recognizer. A relatively large fingerprint area, which contains the rolled image, may be preferably segmented based on a pre-defined position in the detected fingerprint card form in step 200. Generally, the image from block 200 is 1.6 inch by 1.6 inch size with 500 dpi resolution, corresponding to an image that is about 800×800 pixels size. In general, the image has a size of M×M, wherein M is the dimension of the image step. However, step 200 may optionally include pre-processing the fingerprint image, wherein, for instance, the image is down-scaled by a predetermined factor to increase the speed of subsequent image processing. Moreover, typically the fingerprint image is a grayscale image, wherein each pixel has a grayscale or gray value or level that may generally range from 0 and 255.

Statistical information (such as, for instance, at least one histogram and local dynamic range and local mean corresponding to the histograms) corresponding to a print image of step 200 may be calculated in step 300. This statistical information may include gray scale statistical information calculated for each cell of a ridge contour array (RCA) determined in step 400, wherein the statistical information of the each cell ideally includes local dynamic range and local mean. To determine the gray scale statistical information, the total number of gray levels may be scaled from 256 to a factor thereof, for instance to a factor of 4 (i.e., to a total number of 64 gray levels) for faster processing.

Returning to step 400, the RCA is determined for the fingerprint image output as a result of step 200. An RCA is generally defined as a smoothed step direction image, which comprises a plurality of ridge contour cells. Each cell consists of a window box having a designated size of Ne by Ne pixels, where Ne is may, for instance, have a range of about 8 to about 32 pixels, with Ne ideally being 16. To generate this RCA, a direction of each image is determined, and the direction of each cell or block accordingly estimated. The direction for each pixel of the image may be calculated based on a brightness gradient of at least two neighboring pixels in, for example, the x and y directions, thereby generating an estimated gradient vector having a magnitude and a direction that represent the strength of the direction. Neighboring pixels of a given pixel are defined as all those pixels that are adjacent to the given pixel. When determining a gradient vector for a given pixel, the magnitude and orientation of this estimated gradient vector may be unreliable inter alia if a neighboring pixel is in a noisy area. Therefore, any method known in the art for reliably estimating block direction, for instance by smoothing the directional image, may be used to address this noise issue.

One such method known in the art that may be used for estimating block direction and smoothing the directional image is a multi-layer cell pyramid approach. This approach may, thus, be used to estimate an average direction of a given pixel window cell having dimensions Ne pixels by Ne pixels. This pyramid approach determines if the average direction of the given window cell is consistent with the orientation of neighboring cells to effectively smooth the direction of the pixel windows in the directional image. If no effective direction is detected (i.e., there is no consistency), a larger size window may be used. The window size may be increased until an effective direction is determined or until, for instance, a predetermined largest cell window size is reached. For example, a window having the size of four window cells with each cell has Ne×Ne pixel dimensions may be used, and even larger window sizes may be employed, such as, for example, cells having sixteen Ne×Ne pixel dimensions. The result of this type of pyramid multi-layer cell approach is the smoothed ridge contour array in step 400.

The local mean and dynamic range calculated in step 300 for each contour array cell may be used to further modify the respective cells. More specifically, the local mean and dynamic range, may be compared with, for example, at least two pre-determined threshold values (e.g., Tm and Td) to modify the RCA gradient value of the cell. In one representative aspect in accordance with various exemplary embodiments of the present invention, the selection of pre-determined threshold values Tm and Td may correspond to down-scaled (e.g., quantized) gray scale values. Alternatively, conjunctively or sequentially, Tm and Td may also be empirically determined by examining the histograms corresponding to of the local mean and dynamic range.

The goal of establishing initial values for Tm and Td is to make sure that the RCA cell in over dark, over ink, too light, and no ink areas is generally set to correspond to an absence of direction. For example, if the value of the dynamic range and the value of the local mean are both too low for the cell area, the RCA value of the cell is set to indicate that the cell area is too dark and if the dynamic range is too low and the mean is too high, the RCA value of the cell is set to indicate that the cell area is too light or no ink region. In either case, since the cell area is too dark or too light, no direction is generally detected.

The smoothed ridge contour array data determined in step 400 may be further adjusted in step 500 to binarize the RCA and to detect and convex boundaries of the binarized image. Moreover, topological data, such as cores and deltas, may be detected in step 600, using any suitable means known in the art. Coordinates of core and delta information detected in step 600 may be used to fine tune the edges of the block containing the segmented fingerprint as described below by reference to step 1100 of FIG. 4.

Returning to 500, the ridge contour array is preferably binarized into a two level image. One level comprises at least one component image (i.e., a foreground component image) having one or more cells that are associated with a direction. The other level comprises at least one component image (i.e., a background component image) having one or more cells associated with no direction. For example, a cell area that has been associated with a direction and corresponds to the fingerprint image may be set to black, while a cell that does not have a direction and corresponds to background may be set to white.

Ideally, at least one black (or foreground) component of the bi-level image comprising a total number of pixels greater than or equal to a threshold T is detected, and line shaped components and small components near the boundaries of the detected black components are deleted. A line shape component is defined as one having a width not more than 8 pixels of the detected component. A small component is defined as one comprising a total number of pixels that is less than the threshold value T. For instance, T may be optimally set to 55. It is understood; however, that the number T may be found empirically to make sure that the noisy small components are deleted. In the event more than one component of the print image remains, merged or deleted, the smaller component adjacent to the larger may be deleted until only one large component remains.

In step 500, the boundaries of a detected foreground component image may be, for instance, found by scanning each row of the component image from left to right of the image. The left most position from a white to black transition cell is, typically, the left boundary of the component for a given row and the right most position from a black to white transition cell is the right boundary of the component for that row.

As stated above, a detected component image may also be convexed in step 500. Even though a fingerprint exhibits inherent convex properties, a detected component image does not generally demonstrate convex properties due inter alia to background noise and image processing artifacts. Thus, to smooth a boundary line, a component may be convexed in step 500. Boundaries may be smoothed, for instance, by considering successive left most pixels (as well as right most pixels) of neighboring rows and identifying whether a slope of the component is increasing or decreasing monotonically (a general condition for the convex hull). If this condition is violated, the left or right most pixel of the current row may be adjusted to comply with this condition by making it substantially equal to the left most or right most pixel of the current or the previous row.

Based on the left and right boundary determined for a detected component image, a central line of the component image may be found in step 700. Component direction/component orientation is preferably estimated from a central line. One third to two thirds of the rows of the left and right boundaries may be used to estimate a central line. Ideally, a middle position is used to make sure that the central line and component direction computations are robust and reasonable. If the orientation of the component is rotated greater than a predefined threshold of Td degrees, the component image may be rotated back to normal orientation, i.e, less than the threshold Td degrees from a desired orientation.

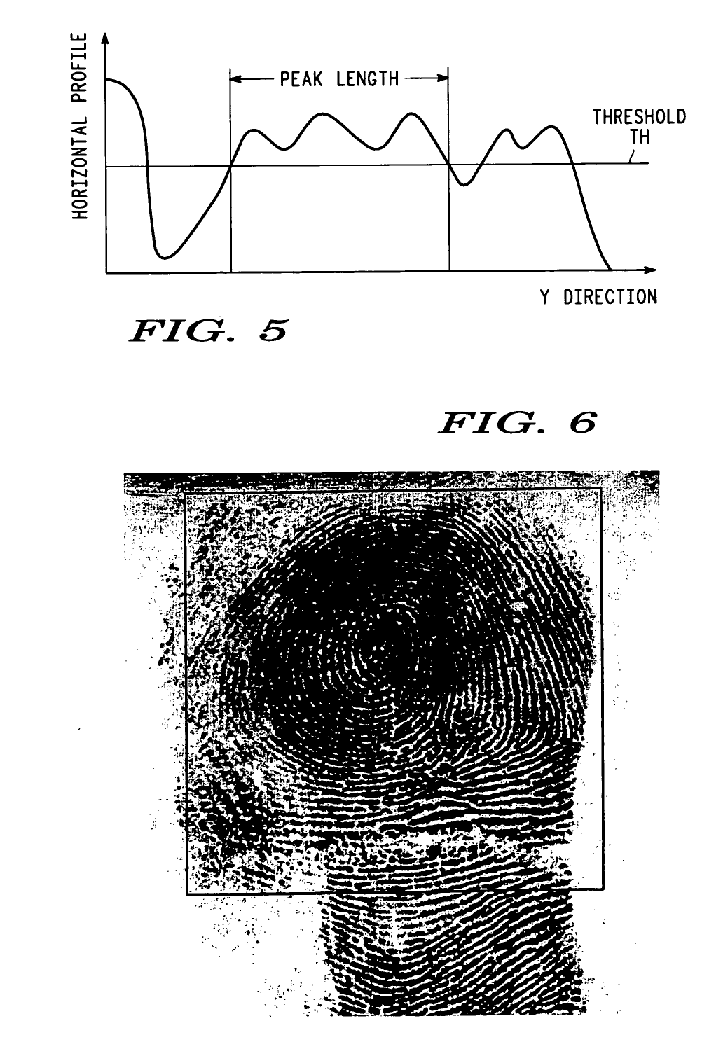

Horizontal and vertical projection profiles and mean values for the profiles of the component may be calculated in step 800. As will be seen by reference to steps 900 and 1000, these profiles are used to generate segmentation edges that are then used for segmenting a fingerprint image in accordance with the present invention. To determine the horizontal and vertical projection profiles of the component image, the number of black cells (having directionality) is preferably accumulated for each row and each column respectively. The horizontal projection profile comprises M/Ne number of projected rows with value equal to the number of valid direction accumulated for that row, and the vertical projection profile consists of M/Ne number of projected columns with value equal to the number of valid direction accumulated for that column. FIG. 5 illustrates a plot of a horizontal projection profile. The mean of a projection profile may be calculated by adding all the projected values for all the rows (or columns) and dividing by a total number of rows (or columns).

In step 900, two threshold values Th and Tv may be assigned using the mean values of horizontal projection profile and vertical projection profile, respectively. The threshold values Th and Tv may then be used to determine peaks and valleys of horizontal projection profiles (HPP) and vertical projection profiles (VPP) as illustrated in step 1000. Specifically, a number of peaks and valleys for the horizontal projection profile and the vertical projection profile may be detected. The numbers of peaks may be detected by checking the projected profile. More specifically, the number of rises and the falls may be detected to determine the number of peaks. A rise is defined at a row/column MR such that the profile value for row/column at MR−1 is less than the threshold Th and the profile value for row/column at MR+1 is greater than the threshold Th. The fall of the peak is defined as the first row/column MD after the row/column MR such that the profile value for row/column MD−1 is greater than the threshold Th and the profile value for row/column MR+1 is less than the threshold Th. A peak length is defined as MD−MR. The maximum peak length is selected by comparing all of the peak lengths detected.

Ideally, the maximum peak length is determined based upon a dynamic threshold. For example, as illustrated in FIG. 5, for a given threshold Th, two peaks are detected. If the number of peaks for the horizontal projection profile is greater than two, threshold Th may be adjusted until; a maximum peak length is determined to be less than a pre-defined threshold Tl; and the threshold value Th is greater than a pre-defined threshold value Tm. Ideally the threshold value Th in step 900 may be changed and the process may be repeated in step 1000 until the above described conditions are met, wherein Tl may be set to the average component height from the top to the crease and Tm may be set to the smallest possible component height. Similarly, if the number of peaks for a vertical projection profile is greater than two, threshold Tv may be adjusted until: a maximum peak length is less than a pre-defined threshold value Tj; and the threshold value Tv is greater than a pre-defined threshold value Tn. Ideally the threshold value Tv in step 900 may be changed and the process may be repeated in step 1000 until the above described conditions are met, wherein Tl is set to the average component width of fingerprints, and Tm is set to the smallest possible component width. The parameter or threshold values are ideally measured in RCA space domain.

In step 1100, four edges of the box containing the segmented fingerprint are ideally computed. A rise point at row MR of the largest peak provides a setting for its initial top edge Yti and a fall point at row MD of the largest peak provides the initial bottom edge Ybi of the component. The top and bottom edges (Yt and Yb) may be calculated as follows:

Yt=(Yti−Ybi)/2−NewImgRow/2;

and If Yt<0, Yt is preferably set to zero.

Yb=(MD−MR)/2+NewImgRow/2;

and If Yb>NewImgRow, Yb is preferably set to NewImgRow.

If Yt−Yb<NewImgRow, an edge which is not on the image boundary is preferably expanded so that Yt−Yb=NewImgRow.

Y coordinates of cores may be compared with the segmented Yt and Yb. If the core's coordinates are close (such as about ⅙ of a segmented NewImgRow) to one of a boundary edge Yt or Yb, Ty and Tb may be shifted so that the edge may be Sd cells away from the core, where Sd>⅙ of a segmented NewImgRow, which may be determined empirically. Variables such as NewImgRow, Yt and Yb may be calculated in terms of the RCA coordinate scale.

The rise point at column MR of the largest peak for the vertical projection profile preferably provides a setting for its initial left edge Xli and the fall point at column MD of the largest peak for the vertical projection profile preferably provides the initial bottom edge Xri of the component. The segmented top and bottom edges (Xl and Xr) may be calculated as follows:

Xl=(Xri−Xli)/2−NewImgCol/2;

and If Xl<0, Xl is preferably set to zero.

Xr=(Xri−Xli)/2+NewImgCol/2;

and If Xr>NewImgCol, Xr is preferably set to NewImgCol.

If Xr−Xl<NewImgCol, an edge which is not on the image boundary may be expanded so that Xr−Xl=NewImgCol.

X coordinates of cores may be compared with the segmented Xl and Xr. If the core's coordinates are too close (such as ⅙ of a segmented NewImgCol) to the segmented center x coordinate, Xl and Xr may be shifted so that the edge may be Sd cells away from the center, where Sd is at least ⅙ NewImgCol farther away to center and may be determined empirically. Parameters, variables or thresholds in the step 1100 may be measured in terms of the RCA coordinate scale.

In step 1100, the component boundary and the four detected edges may be converted from RCA space back to original fingerprint image space coordinates. The coordinates of each boundary point may be, for instance, multiplied by a factor M/Ne to convert the RCA space back to the original image space. The rest of the points between the boundary points may be determined by linear interpolation. A segmented image obtained according to a preferred embodiment is shown in step 1100 of FIG. 5. Boundary information detected in step 500 may then be used during subsequent minutiae matching detection to discard false minutiae detected outside of the fingerprint boundary.

It will be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate corresponding elements.

Similarly, the software elements of the present invention may be implemented with any programming or scripting language such as, for example, C, C++, Java, COBOL, assembler, PERL, eXtensible Markup Language (XML), etc., or any programming or scripting language now known or hereafter derived in the art, with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

It will be appreciated, that many applications of the present invention could be formulated. One skilled in the art will appreciate that the network may include any system for exchanging data, such as, for example, the Internet, an intranet, an extranet, WAN, LAN, satellite communications, and/or the like. It is noted that the network may be implemented as other types of networks, such as an interactive television (ITV) network. The users may interact with the system via any input device such as a keyboard, mouse, kiosk, personal digital assistant, handheld computer (i.e., Palm Pilot(r)), cellular phone and/or the like. Similarly, the invention could be used in conjunction with any type of personal computer, network computer, workstation, minicomputer, mainframe, or the like running any operating system such as any version of Windows, Windows XP, Windows Whistler, Windows ME, Windows NT, Windows2000, Windows 98, Windows 95, MacOS, OS/2, BeOS, Linux, UNIX, or any operating system now known or hereafter derived by those skilled in the art. Moreover, the invention may be readily implemented with TCP/IP communications protocols, IPX, Appletalk, IP-6, NetBIOS, OSI or any number of existing or future protocols. Moreover, the system contemplates the use, sale and/or distribution of any goods, services or information having similar functionality described herein.

The computing units may be connected with each other via a data communication network. The network may be a public network and assumed to be insecure and open to eavesdroppers. In one exemplary implementation, the network may be embodied as the internet. In this context, the computers may or may not be connected to the internet at all times. A variety of conventional communications media and protocols may be used for data links, such as, for example, a connection to an Internet Service Provider (ISP) over the local loop as is typically used in connection with standard modem communication, cable modem, Dish networks, ISDN, Digital Subscriber Line (DSL), or various wireless communication methods. Polymorph code systems might also reside within a local area network (LAN) which interfaces to a network via a leased line (T1, T3, etc.). Such communication methods are well known in the art, and are covered in a variety of standard texts.

As will be appreciated by one of ordinary skill in the art, the present invention may be embodied as a method, a system, a device, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Data communication is accomplished through any suitable communication means, such as, for example, a telephone network, Intranet, Internet, point of interaction device (point of sale device, personal digital assistant, cellular phone, kiosk, etc.), online communications, off-line communications, wireless communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The present invention is described herein with reference to screen shots, block diagrams and flowchart illustrations of methods, apparatus (e.g., systems), and computer program products according to various aspects of the invention. It will be understood that each functional step of the block diagrams and the flowchart illustrations, and combinations of functional steps in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart steps or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart steps or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart steps or blocks.

Accordingly, functional steps of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional steps in the block diagrams and flowchart illustrations, can be implemented by either special purpose hardware-based computer systems which perform the specified functions or steps, or suitable combinations of special purpose hardware and computer instructions.

In the foregoing specification, the invention has been described with reference to specific embodiments. However, it will be appreciated that various modifications and changes can be made without departing from the scope of the present invention as set forth in the claims below. The specification and figures are to be regarded in an illustrative manner, rather than a restrictive one, and all such modifications are intended to be included within the scope of present invention. Accordingly, the scope of the invention should be determined by the appended claims and their legal equivalents, rather than by merely the examples given above. For example, the steps recited in any of the method or process claims may be executed in any order and are not limited to the order presented in the claims.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”. Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing or design parameters or other operating requirements without departing from the general principles of the same.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

Moreover, the term “a” or “an”, as used herein, are defined as one or more than one. The term “plurality”, as used herein, defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “set of instructions”, as used herein, is defined as a sequence of instructions designed for execution on a microprocessor or computer system. A program or set of instructions may include a subroutine, a function, a procedure, an object method, an object implementation, an executable application, an applet, a servlet, a source code, an object code, a shared library/dynamic load library and/or other sequence of instructions designed for execution of a computer system.

What is claimed is:

1. A method for segmenting a fingerprint image having a plurality of pixel, said fingerprint image being the image of a fingerprint, said method comprising the steps of:
estimating the direction of at least a portion of said plurality of pixels to generate a directional image from said fingerprint image;
determining at least one foreground component image of said directional image;
calculating a vertical projection profile of said at least one foreground component image;
calculating a horizontal projection profile of said at least one foreground component image;
determining a plurality of segmentation edges based on said vertical and horizontal projection profiles; and
segmenting a region of said fingerprint image based on said plurality of segmentation edges, whereby said region is included within said segmentation edges.

2. The method of claim 1 further comprising preprocessing said fingerprint image before generating said directional image, said preprocessing including down-scaling said fingerprint image.

3. The method of claim 1 further comprising the step of calculating statistical information from said fingerprint image.

4. The method of claim 3, wherein said statistical information includes at least one of a histogram of said fingerprint image, a dynamic range and a local mean value.

5. The method of claim 3, wherein said statistical information is used to modify said directional image.

6. The method of claim 1, said fingerprint image further comprising cores and deltas, and said method further comprising the step of detecting the location of at least a portion of said cores and deltas from said directional image.

7. The method of claim 6, wherein said cores and deltas are used to modify said segmentation edges.

8. The method of claim 1, wherein said at least one foreground component is determined by binarizing said directional image into a two level image comprising a first level image that includes at least one foreground component image having a direction and a second level image comprising at least one background component image having no direction.

9. The method of claim 1 further comprising sorting said at least one foreground component image according to component image size.

10. The method of claim 9 further comprising selecting a largest foreground component image for calculating said vertical and horizontal projection profiles.

11. The method of claim 1 further comprising the step of detecting boundaries of said at least one foreground component image, including at least one left and one right boundary.

12. The method of claim 11 further comprising convexing the boundaries of said at least one foreground component.

13. The method of claim 12 further comprising convexing said at least one foreground component image by computing the convex hull.

14. The method of claim 11 further comprising generating a central line between said at least one left and right boundary for estimating an orientation of said at least one component.

15. The method of claim 14 further comprising rotating said at least one foreground component image to within a predefined threshold of a desired orientation.

16. The method of claim 1 further comprising smoothing said directional image using a multi-cell pyramid approach.

17. The method of claim 1, wherein said fingerprint image is a grayscale image and said plurality of pixels each have a gray value determined from a set of gray values, and said method further comprising down-scaling said set of gray values.

18. The method of claim 17, wherein said set of gray values is down-scaled by a factor of four.

19. The method of claim 1 further comprising:
determining a maximum vertical peak length from said vertical projection profile; and
determining a maximum horizontal peak length from said horizontal projection profile, whereby said plurality of segmentation edges are determined based on said maximum vertical peak length and said maximum horizontal peak length.

20. The method of claim 19 further comprising:
for said vertical projection profile detecting at least one peak rise and a corresponding peak fall based upon a first threshold for determining said maximum vertical peak length; and
for said horizontal projection profile detecting at least one peak rise and a corresponding peak fall based upon a second threshold for determining said maximum horizontal peak length.

21. The method of claim 20, wherein said first and second thresholds are dynamic thresholds.

22. The method of claim 19, wherein said maximum vertical peak length is used to determine a top and bottom segmentation edge, and said maximum horizontal peak length is used to determine a left and right segmentation edge.

23. The method of claim 1, wherein each said segmentation edge has a predetermined length.

24. The method of claim 1 further comprising detecting a fingerprint crease, wherein said region is located above the crease.

25. A system for segmenting a fingerprint image having a plurality of pixel, said fingerprint image being the image of a fingerprint, said system comprising:
means for estimating the direction of at least a portion of said plurality of pixels to generate a directional image from said fingerprint image;
means for determining at least one foreground component image of said directional image;
means for calculating a vertical projection profile of said at least one foreground component image;
means for calculating a horizontal projection profile of said at least one foreground component image;
means for determining a plurality of segmentation edges based on said vertical and horizontal projection profiles; and
means for segmenting a region of said fingerprint image based on said plurality of segmentation edges, whereby said region is included within said segmentation edges.
